(19) United States
(12) Patent Application Publication
(10) Pub. No.: US 2011/0308048 A1
(43) Pub. Date: Dec. 22, 2011

(54) CLIP WITH MAGNETIC DETENT FOR SECURING LIGHTER TO PACK OF CIGARETTES

(75) Inventor: Enrico RACCAH, Miami, FL (US)

(73) Assignee: Racca Enterprises, Inc., Miami, FL (US)

(21) Appl. No.: 13/161,957

(22) Filed: Jun. 16, 2011

Related U.S. Application Data
(60) Provisional application No. 61/344,239, filed on Jun. 17, 2010.

(51) Int. Cl. F16B 2/20; H01F 7/02

(52) U.S. Cl. 24/303

(57) ABSTRACT

A resilient clip can be secured to a pack of cigarettes. The clip comprising a pair of parallel legs joined by a U-shaped, upwardly opening bend; the clip is slipped into engagement with the pack of cigarettes, and one wall of the pack is grasped therebetween. A resilient band encircles the perimeter of a lighter. A magnetic member on one of the legs of the clip fits into a recess in a magnetic detent incorporated into the resilient band, so that the cigarette lighter is retained in proximity to the clip and the pack of cigarettes. The lighter is always available to light the cigarettes when withdrawn from the pack.

### CROSS-REFERENCE TO RELATED APPLICATIONS

This application claims the benefit of U.S. Provisional Application No. 61/344,239, filed Jun. 17, 2011, in the United States Patent and Trademark Office, the disclosure of which is incorporated herein by reference.

### BACKGROUND OF THE INVENTION

The clip of the present invention is inserted into the space between the overwrap for a pack of cigarettes and the exterior of the pack. A magnetic member is formed on the clip, and cooperates with a magnetic detent on a band that includes a cigarette lighter. The magnetic member and detent are drawn together by the magnetic forces, so that the cigarette lighter is retained adjacent to the pack of cigarettes, available for igniting a cigarette withdrawn from the pack.

Presently, smokers retain packs of cigarettes, in pockets in their garments. Lighters are also retained in pockets, or carrying cases, or pocketbooks, or purses, but usually separate from the cigarettes. In order to light a cigarette, the user must locate the cigarette pack and the lighter, and then bring the two objects into an operative relationship.

### SUMMARY OF THE INVENTION

The present invention provides a clip, including a magnet, that is readily joined to a pack of cigarettes; and a band that encircles a lighter. A magnetic detent is located on the band. The magnetic attraction between the magnet and the magnetic detent normally retains the lighter in proximity to the cigarette pack. When the user wishes to light a cigarette, he, or she, pulls the cigarette lighter away from the pack of cigarettes, creates a flame, and ignites the cigarette. The lighter, is then returned to its initial position, within the resilient band. The attraction between the magnet and the magnetic detent is maintained during such procedure.

The clip is a U-shaped member comprising pair of upstanding, spaced, parallel legs connected at their lower ends by a U-shaped bend. The clip may be made of metal or rigid plastic, and is an integral member. The owner or manufacturer's name may be imprinted upon one arm to personalize same, or identify the distributor of the clip, etc.

The band encircling the lighter is fabricated of a resilient material that functions satisfactorily with a variety of different sizes, and shapes, of lighters. The band may be made of wool, knit fabrics, Velcro, or plastic, and may be brightly colored and/or embellished by team logos, advertisements, etc.

A magnet is secured to one arm of the clip, and a magnetic detent is affixed to the band. The magnet fits within the detent, so the clip and band are properly aligned and magnetically attached to one another. The clip and band posses no moving parts, so the clip and band may be used for an extended period of time, extending over several packs of cigarettes or cigars.

The clip and band are relatively inexpensive to manufacture, and thus may be distributed as a novelty item for promoting commercial ventures, athletic events, or sold or distributed as souvenirs, etc.

### BRIEF DESCRIPTION OF THE DRAWINGS

FIG. 1 is a perspective view of applicant's clip slipped into engagement with a pack of cigarettes, and a cigarette lighter with a resilient band for retaining the lighter in proximity to the cigarettes;

FIG. 2 is a perspective view of the clip and the resilient band prior to joining same together;

FIG. 3 is a side elevational view if the clip and resilient band joined together by magnetic attraction;

FIG. 3A is a side elevational view of the clip in FIGS. 1-3;

FIG. 3B is a rear view of the clip of FIGS. 1-3; and

FIGS. 4 and 5 show the details of the magnet on the clip and the magnetic detent on the resilient band that encircles the cigarette lighter.

### DETAILED DESCRIPTION OF PREFERRED EMBODIMENTS

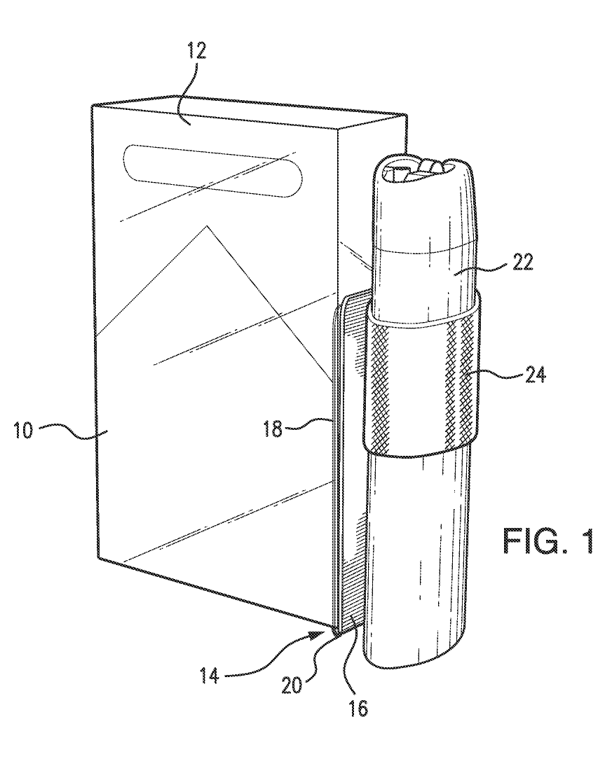

FIG. 1 shows a conventional rectangular, rigid package 10 for retaining cigarettes. A clear plastic overwrap 12 covers package 10, at the time of purchase, to prevent tampering and to keep moisture, odors, etc. from degrading the quality of the cigarettes.

A U-shaped clip indicated generally by reference numeral 14, comprises an outer leg 16 and an inner leg 18 with an upwardly opening bend 20. Legs 16 and 18 are equal in size, and extend parallel to one another. Leg 18 is slipped through overwrap 12 and contacts an interior wall of package 10. Leg 16 contacts the exterior of the same wall, and anchors the clip upon the package. Leg 18 presses against the exterior wall of package 10. The legs are resilient and securely grip the lower corner of package 10 therebetween. The exposed edges of the legs may be chamfered to easily penetrate overwrap 12 and package 10.

A cigarette lighter 22 is held in operative relationship to package 10, and the cigarettes retained therein, by a resilient band 24 that encircles lighter 22.

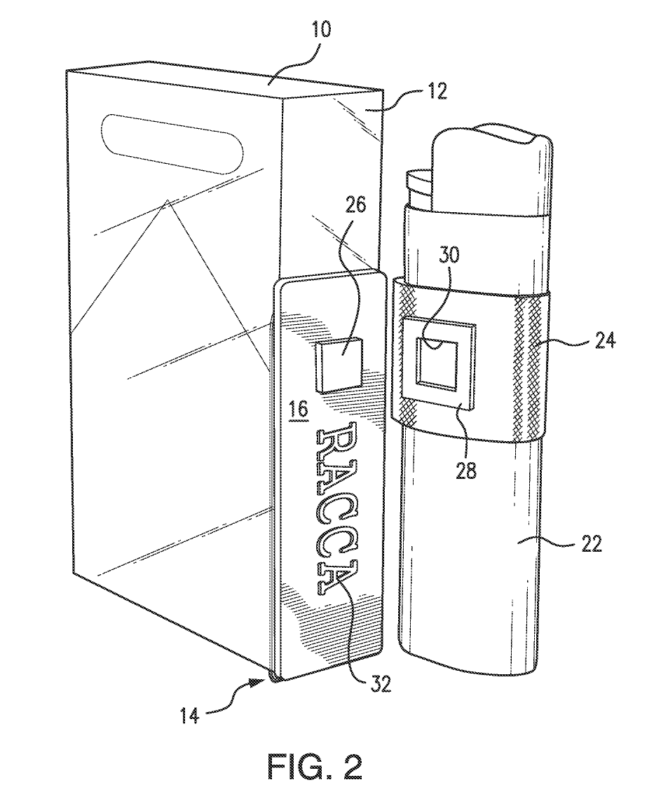

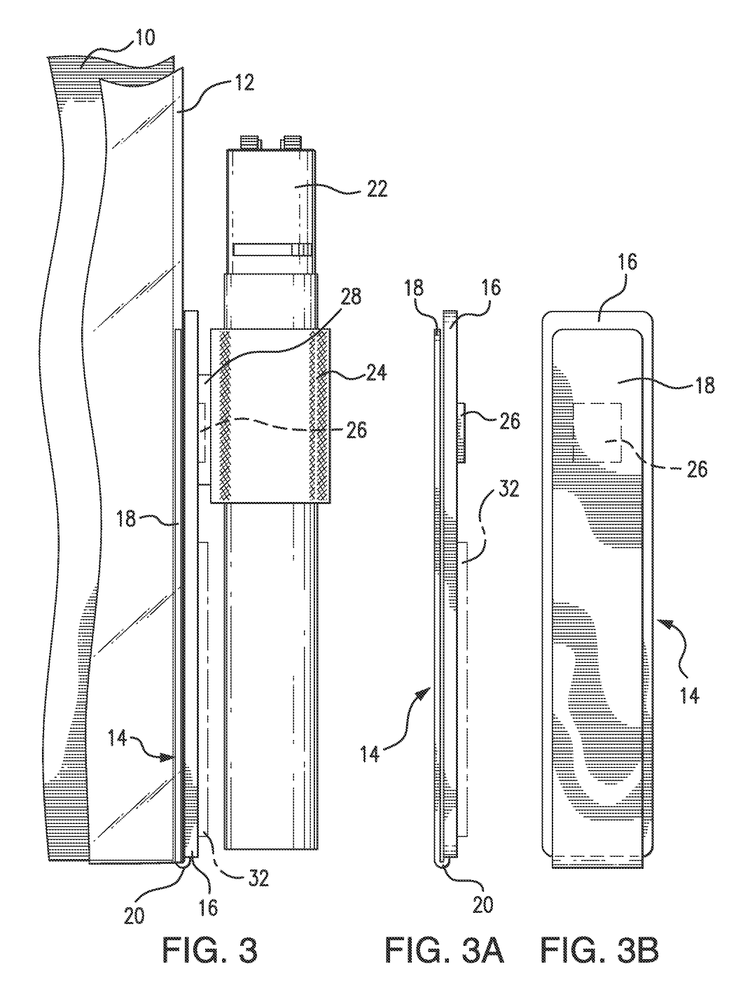

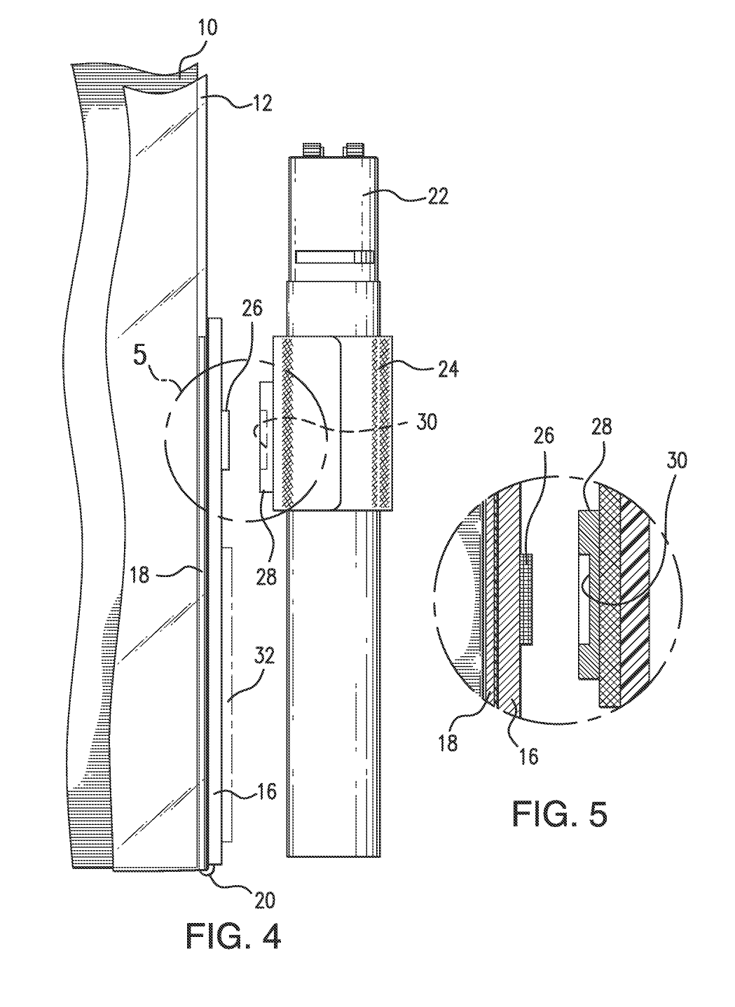

When FIG. 1 shows lighter 22 in operative relation to package 10, FIG. 2 shows lighter 22, and resilient band 24 for lighter 22, prior to such joinder. A rectangular magnet 25 is located toward the upper end of leg 16, and a magnetic detent 26 is located on the exterior of band 24. Magnet 26 is sized to fit within the recess 30 in magnetic detent 28. The name 32 of the manufacturer or distributor of the clip and resilient band may be formed on leg 16, or label may be affixed thereto. Alternatively, the name of the owner of the clip may appear on the clip to personalize same.

Various modifications and revisions may occur to the skilled artisan from the forgoing description of applicant's invention. For example, the clip may be secured to a package of cigars, and the clip may be secured directly to a sidewall of the pack, if an overwrap of cellophane or foil has been removed or omitted. The cigarette, or cigar, pack may be made of paper, or foil, or combinations of both materials. The location of the magnet and the magnetic detent may be altered, so that the detent appears on the clip and the magnet is secured to the band.

Band 24 may be made of a resilient material that fits snugly above the circumference or perimeter of lighter 22, or may be formed from a band with overlapping ends secured together by Velcro fasteners. Lighter 22 may be slipped into, and out of, resilient band 24 as needed. The band may be retained in engagement with clip 14 by virtue of the attractive forces of magnet 26 and magnetic detent 28, 30. Consequently, the appended claims should be broadly construed in accordance with the spirit and scope of the invention, and should not be limited to their literal terms.

1. A clip and a band adapted to secure a cigarette pack to a lighter,
a) said clip comprising a pair of parallel legs spaced apart by a U-shaped bend,
b) the space between the legs being narrow enough to enable the legs to be engaged with opposite sides of a segment of a cigarette pack,
c) a band adapted to fit snugly around the perimeter of a cigarette lighter,
d) magnetic means defined between said clip and said band for retaining the lighter in proximity to said clip.

2. A clip and a band a recited in claim 1 wherein a magnet is secured to one leg of said clip, and a magnetic detent is defined on said band.

3. A clip and a band as recited in claim 2 wherein a recess is formed within said magnetic detent, and said magnet fits within said recess.

4. A clip and a band as recited in claim 3 wherein said magnet is rectangular in shape, and said recess in said magnetic detent is rectangular in shape, but slightly larger in size.

5. A clip and a band as recited in claim 1 wherein said band is made of resilient material, so that said band can fit snugly about lighters of different dimensions.

6. A clip and a band as recited in claim 1 wherein said clip is an integral member formed of a metal or plastic material.

7. A clip and a band as recited in claim 1 wherein indicia are located on the outer exposed surface of a leg of said clip.
